(19) United States
(12) Patent Application Publication
(10) Pub. No.: US 2017/0174049 A1
(43) Pub. Date: Jun. 22, 2017

(54) DYNAMICALLY CONTROLLED VAPOR COMPRESSION COOLING SYSTEM WITH CENTRIFUGAL COMPRESSOR

(71) Applicant: FORD GLOBAL TECHNOLOGIES, LLC, Dearborn, MI (US)

(72) Inventors: Jing He, Novi, MI (US); Loren John Lohmeyer, III, Monroe, MI (US); William Stewart Johnston, South Lyon, MI (US)

(21) Appl. No.: 14/976,490

(22) Filed: Dec. 21, 2015

(51) Int. Cl. B60H 1/32; F04D 25/06; B60H 1/00; F04D 29/28; F04D 29/44; F04D 17/12; F04D 27/00

(52) U.S. Cl. CPC B60H 1/3222; F04D 17/122; F04D 25/06; F04D 27/004; F04D 27/002; F04D 29/284; F04D 29/441; B60H 1/3205; B60H 1/00385; F05B 2270/1033; F05B 2270/303; F05B 2270/301; B60H 2001/327; B60H 2001/3272; B60H 2001/3292; B60H 2001/3285; B60H 2001/326; B60H 2001/3255; B60H 2001/3248; B60H 2001/3245; B60H 2001/3261

(57) ABSTRACT

A vapor compression cooling system includes a centrifugal compressor(s) for compressing a primary fluid in a cycle including at least two compressions, and a control module for controlling the centrifugal compressor dependent upon at least a condition of a secondary fluid. The module controls a power of the centrifugal compressor by adjusting a speed of the motor driving the compressor and/or an opening of guide vanes associated with at least one impeller. The module may also control a pressure drop of a primary fluid moving through at least one expansion device. The at least two compressions may be made in parallel or in series. A related method includes compressing a primary fluid in a first and a second compression cycle and adjusting a parameter of the compressor dependent upon a calculated desired power of the compressor.

### TECHNICAL FIELD

This document relates generally to vapor compression cooling systems, and more specifically to a dynamically controlled vapor compression cooling system utilizing a centrifugal compressor.

### BACKGROUND

Progressive global warming legislation is constantly driving the heating, ventilation, air-conditioning and refrigeration (HVAC&R) industry to seek out and use environmentally friendly refrigerants. In the automotive sector, for example, the traditionally used refrigerant, R134a, is a fluorinated greenhouse gas (F-gas) with a high Global Warming Potential (GWP) of 1,430. EU Directive 2006/40/EC requires mandatory phase-out of R134a by Jan. 1, 2017, for passenger and light commercial vehicles. In the US, the Environmental Protection Agency (EPA) and the National Highway Traffic Safety Administration (NHTSA) have similarly developed the One National Program in order to reduce greenhouse gas emissions and improve fuel economy and, most recently, the EPA has listed R134a as unacceptable for use in newly manufactured light-duty vehicles beginning in Model Year 2021 with limited exceptions. The synthetic refrigerant, R1234yf, is introduced as a near drop-in alternate to R134a with a relatively low GWP of 4 and similar thermodynamic properties. A limited supply and high price of R1234yf, however, have created concern and some OEMs consider R1234yf to be an interim replacement while they continue to study alternate solutions. One alternate solution is the use of R744 (carbon dioxide). R744 offers a lower cost, non-flammability, high volumetric heat capacity, and perhaps most importantly, environmental friendliness. R744 is a natural occurring substance having an ODP=0 and a GWP=1.

In addition to utilizing environmentally friendly refrigerants, it is also desirous for new climate control systems to improve overall system performance in terms of energy efficiency and effectiveness. One drawback of utilizing R744 in these climate control systems is a reduction in efficiency as the temperature of the fluid used to cool the refrigerant in the system rises. For example, when a gas cooler is cooled by air, the systems are generally considered more effective below 35-40 degrees Celsius. Accordingly, a need exists for climate control systems that overcome these noted limitations and operate efficiently in warm regions. More specifically, such systems would utilize a primary fluid having low GWP values, such as the natural refrigerant R744, and maintain their effectiveness over the entire operating range. In other words, the systems should operate efficiently for high ambient conditions above 35-40 degrees Celsius.

One possible solution is the utilization of centrifugal compressor units within the climate control system. Centrifugal compressor units have been widely used in commercial and industrial applications and are known to utilize variable speed motors, magnetic bearings, power electronics controls, and sensors at each magnetic bearing to ensure precise positioning of the shaft. Each of these features improves performance. Combining these types of features with advanced compression technologies, such as parallel or multistage compression and the utilization of expanders for work recovery, may provide the desired high efficiency, environmentally friendly solution that overcomes the noted limitations and operates efficiently over the entire operating range.

### SUMMARY OF THE INVENTION

In accordance with the purposes and benefits described herein, a vapor compression cooling system is provided. The cooling system may be broadly described as comprising a centrifugal compressor for compressing a primary fluid in a cycle including at least two compressions, and a control module for controlling the centrifugal compressor dependent upon at least one condition of a secondary fluid.

In one possible embodiment, the control module controls a power of the centrifugal compressor. In another possible embodiment, the centrifugal compressor is an electric compressor driven by a motor, and the control module controls the power of the electric centrifugal compressor by adjusting a speed of the motor. In yet another possible embodiment, the centrifugal compressor includes first and second impellers driven by the motor and the control module controls the power of the electric centrifugal compressor by adjusting an opening of guide vanes associated with at least one of the first and second impellers.

In another possible embodiment, the centrifugal compressor includes first and second impellers and an expander driven by a motor. In still another possible embodiment, the first and second impellers operate in parallel. In another, the first and second impellers operate in stages. In yet another possible embodiment, the centrifugal compressor includes a single shaft driven by the motor and shared by the first and second impellers and the expander.

In one other possible embodiment, the vapor compression cooling system further includes first and second expansion devices, and the control module further controls the first and second expansion devices dependent upon at least a condition of a secondary fluid.

In another possible embodiment, the vapor compression cooling system further includes a first temperature sensor for sensing a temperature of the primary fluid outlet from a first heat exchanger, and a second temperature sensor and a first pressure transducer for sensing a temperature and a pressure of the primary fluid outlet from an accumulator, wherein the control module controls the centrifugal compressor dependent upon the condition of the secondary fluid, the first sensed temperature, the second sensed temperature, and the first sensed pressure.

In still another possible embodiment, the first and second expansion devices are electronic expansion devices, and the control module controls a pressure drop of the primary fluid moving through the first second expansion devices.

In yet another possible embodiment, the secondary fluid is at least one of air, water, coolant, and refrigerant, and the condition of the secondary fluid includes at least one of a temperature of the secondary fluid, a humidity of the secondary fluid, and an ambient solar load.

In another possible embodiment, the control module controls a power of the centrifugal compressor, and the centrifugal compressor is an electric compressor driven by a motor, and the control module controls the power of the electric centrifugal compressor by adjusting at least one of a speed of the motor and an opening of guide vanes in the centrifugal compressor.

In another possible embodiment, a vapor compression cooling system includes a centrifugal compressor having at least two impellers for compressing a primary fluid in a cycle including at least two compressions, a first heat exchanger through which the primary fluid moves, a first expansion device through which the primary fluid moves, a separator for separating vapor and liquid of the primary fluid, a second expansion device through which the primary fluid moves, a second heat exchanger for boiling the primary fluid, an accumulator for storing liquid primary fluid and allowing vapor primary fluid to enter the centrifugal compressor, and a control module for controlling the centrifugal compressor and the first and the second expansion devices dependent upon a condition of the secondary fluid. In another possible embodiment, the cooling system further includes a bypass valve for adjusting a suction pressure of at least one of first and second impellers.

In still another possible embodiment, the control module further controls the compressor and the first and second expansion devices dependent upon at least one of a first temperature of the primary fluid between the first heat exchanger and the first expansion device, a second temperature of the primary fluid between an accumulator and the compressor, and a pressure of the primary fluid between the accumulator and the compressor.

In accordance with the purposes and benefits described herein, a method is provided of operating a vapor compression cooling system. The method may be broadly described as comprising the steps of: (a) compressing a primary fluid in a first and a second compression cycle of a centrifugal compressor having first and second impellers; (b) determining a condition of a secondary fluid; (c) sensing a temperature of the primary fluid outlet from a first heat exchanger; (d) sensing a temperature and a pressure of the primary fluid outlet from an accumulator; (e) calculating a desired power of the centrifugal compressor based on the condition of the secondary fluid, the sensed temperature outlet from the first heat exchanger, and the sensed temperature and pressure of the fluid outlet from the accumulator; and (f) adjusting a parameter of the centrifugal compressor dependent upon the calculated desired power of the centrifugal compressor.

In one possible embodiment, the step of adjusting a parameter of the centrifugal compressor includes adjusting at least one of a speed of a motor driving the centrifugal compressor and an opening of guide vanes in the centrifugal compressor.

In another possible embodiment, the method further includes the steps of calculating a desired pressure drop based on the condition of the secondary fluid, the sensed temperature outlet from the first heat exchanger, and the sensed temperature and pressure outlet from the accumulator, and changing a pressure of the primary fluid dependent upon the calculated desired pressure drop.

In yet another possible embodiment, the step of changing the pressure of the primary fluid includes adjusting an opening size of at least one expansion device through which the primary fluid moves.

In the following description, there are shown and described several embodiments of a vapor compression cooling system and related methods of operating the system. As it should be realized, the methods and systems are capable of other, different embodiments and their several details are capable of modification in various, obvious aspects all without departing from the methods and assemblies as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the vapor compression cooling system and related methods and together with the description serve to explain certain principles thereof. In the drawing figures:

FIG. 1 is a schematic diagram of a vapor compression cooling system having a centrifugal compressor; and

FIG. 2 is a pressure-enthalpy diagram of the vapor compression cooling system having a centrifugal compressor utilizing parallel compressions;

FIG. 3 is a schematic diagram of an alternate embodiment of a vapor compression cooling system having a centrifugal compressor operating in a multistage compression configuration; and

FIG. 4 is a pressure-enthalpy diagram of the vapor compression cooling system having a centrifugal compressor utilizing multi-stage compressions.

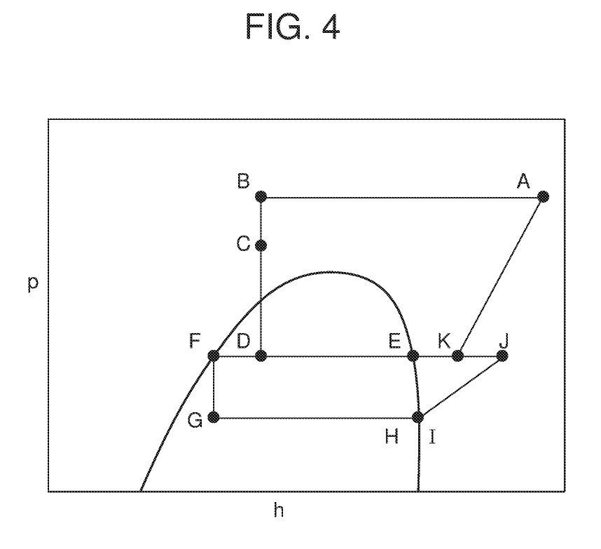

Reference will now be made in detail to the present preferred embodiments of the vapor compression cooling system and related methods of operating the system, examples of which are illustrated in the accompanying drawing figures, wherein like numerals are used to represent like elements.

### DETAILED DESCRIPTION

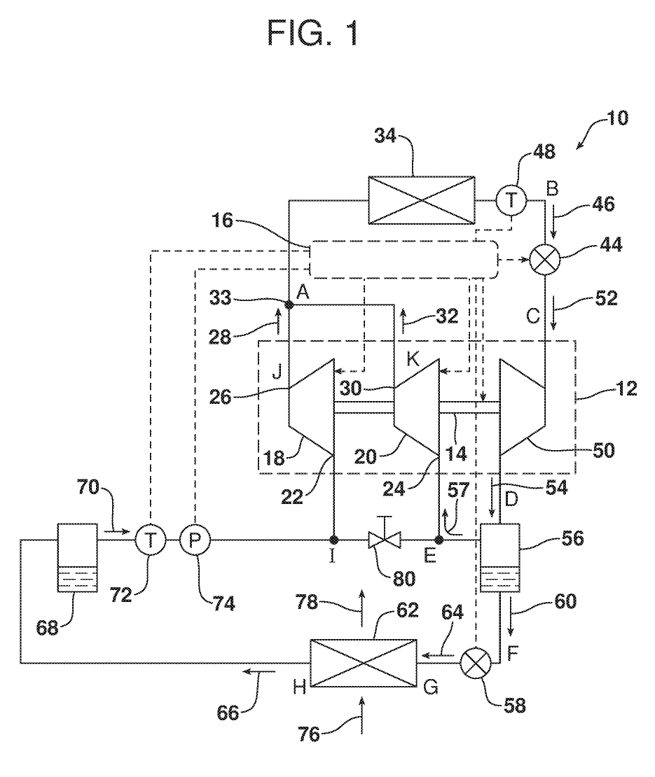

Reference is now made to FIG. 1 which illustrates a schematic diagram of a vapor compression cooling system 10 including a compressor 12. In the described embodiment, the cooling system 10 is a R744 air conditioning system using parallel compressions with a dynamically controlled single-shaft centrifugal compressor 12. The described system provides a low noise, oil-free, high efficiency, environmentally friendly cooling solution in both warm and cold regions. When applied to automotive climate control, the system is considered most suitable for hybrid and electric vehicles using electric compressors driven by a variable speed motor. In hybrid and electric vehicles, the system increases, if not significantly increases, driving ranges. Even more, centrifugal compressors run 100% oil-free through the use of axial and radial magnetic bearings. The oil-free technology eliminates oil compatibility issues, oil-related compressor failures, the need for recycling and servicing oil, and the degradation of other components, for example less heat transfer in heat exchangers and higher pressure drops in AC lines.

In the described embodiments, the compressor includes dual impellers and an expander driven by a single shaft. As shown in FIG. 1, the single shaft 14 is driven by a variable speed motor (not shown). Even more, the described compressor 12 uses magnetic radial and axial bearings that allow for high impeller speeds with minimum friction, reduced size and energy loss.

A control module 16 is electrically connected to the compressor 12 (as shown by dashed line) and adjusts a speed of first and second impellers 18, 20 and the shaft 14 and/or guide vane openings within the first and second impellers dependent upon at least a condition of a secondary fluid that provides heat to a primary fluid (e.g., a refrigerant). The condition of the secondary fluid may include, for example, a temperature of the fluid at various positions associated with the cooling system 10 as described in more detail below. When the described cooling system is used for vehicle cabin cooling, the control module 16 may be a powertrain control module (PCM) connected via a CAN bus. The module is responsive to a switch (or other input means) operated by an occupant in the vehicle. Of course, in alternate embodiments, any control module in the vehicle could be utilized to control the system.

Returning to the described embodiment shown in FIG. 1, the first impeller 18 and the second impeller 20 of the compressor 12 operate in parallel. In this arrangement, a first fluid (e.g., an R744 refrigerant) in the form of a gas or vapor enters first and second suction ports 22, 24 and is compressed by the first and second impellers 18, 20. This cycle includes two compressions that occur at substantially the same time, i.e., in parallel, and compress the vapor refrigerant into a high-pressure, high-temperature vapor refrigerant. In an alternate embodiment described below, a cycle may include two compressions that occur in multiple stages, i.e., serially, or more than two staged or parallel compressions.

The high-pressure, high-temperature vapor refrigerant compressed by the first impeller 18 exits the compressor 12 via a first discharge port 26 as shown by action arrow 28. Similarly, a high-pressure, high-temperature vapor refrigerant compressed by the second impeller 20 in the second compression exits the compressor 12 via a second discharge port 30 as shown by action arrow 32. The first and second high-pressure, high-temperature vapor refrigerants are combined at merger point 33 and fed to a first heat exchanger 34. In the described embodiment where the first fluid is an R744 refrigerant, the first heat exchanger 34 is a gas cooler. Within the gas cooler, the high-pressure, high-temperature vapor refrigerant is cooled to a high-pressure, low-temperature vapor by a cooling fluid, for example ambient air or water. The fluid flow over the first heat exchanger 34 may be created and regulated by fans for air or pumps for water.

The cooled, high-pressure refrigerant is sent to a first expansion device 44 as shown by action arrow 46. A thermocouple 48 senses a temperature (T₁) of the refrigerant outlet from the first heat exchanger 34 prior to entering the first expansion device 44. Although the thermocouple 48 is depicted in FIG. 1 adjacent an outlet of the first heat exchanger 34, the thermocouple, or a different type of temperature sensor in an alternate embodiment, could be positioned near an inlet of the first expansion device 44, or anywhere between the two devices. The thermocouple 48 is electrically connected (as shown by dashed line) to the control module 16 which receives the sensed temperature (T₁) of the refrigerant for use in calculating a desired power of the compressor 12.

The desired power is calculated using the sensed temperature (T₁), a second sensed temperature (T₂) and a sensed pressure (P₁) of the refrigerant, and the condition of the secondary fluid (e.g., a temperature of the secondary fluid at an inlet or an outlet of a second heat exchanger 62) that provides heat to the refrigerant. In the described embodiment, a temperature sensor (not shown) senses the secondary fluid temperature (T_{A}) and the result is the condition of the secondary fluid provided to the control module 16. The second sensed temperature (T₂) and the sensed pressure (P₁) are likewise provided to the control module 16 and will be described in more detail below. Depending upon the calculated desired power, a parameter of the compressor 12 may be adjusted. For example, a speed of the motor or shaft of the compressor 12 and/or guide vane openings of the impellers may be adjusted to ensure optimal performance.

In the first expansion device 44, the outlet refrigerant from the first heat exchanger 34 is expanded and supplied to an expander 50 of the compressor 12 as shown by action arrow 52. The expander 50 expands the refrigerant to produce work that is used to drive the shaft 14 of the centrifugal compressor 12. The recovery of expansion work reduces the compressor load and improves system efficiency.

In the described embodiment, the control module 16 is electrically connected to the expansion device 44 (as shown by dashed line) and operates to control a pressure drop of the refrigerant moving through the expansion device to ensure optimal performance. In the described embodiment, the first expansion device 44 is an electronic expansion device having an opening therein which the refrigerant passes through. The control module 16 controls a size of the opening within the expansion device 44. The size of the opening determines the pressure drop of the refrigerant moving through the device 44. The pressure drop is adjusted dependent upon the same inputs used to calculate the desired power of the compressor by the control module 16. In alternate embodiments, the expansion device could be fixed orifice tubes with associated bypass devices that together provide a specific drop in pressure.

An intermediate-temperature, intermediate-pressure vapor and liquid refrigerant mixture leaves the expander 50, as shown by action arrow 54, and is received in a separator 56. An intermediate-pressure, intermediate-temperature vapor refrigerant exits the separator 56, as shown by action arrow 57, and is received in the second impeller 20 of the compressor 12 where the vapor refrigerant is again compressed and cycled through the system 10. The separated liquid refrigerant within the separator 50 is then sent as an intermediate-pressure, intermediate-temperature liquid refrigerant to a second expansion device 58 as shown by action arrow 60.

In the second expansion device 58, the outlet liquid refrigerant from the separator 50 is expanded to become a low-pressure, low-temperature vapor and liquid refrigerant mixture that is supplied to a second heat exchanger 62 as shown by action arrow 64. Regulation of the flow of refrigerant through the expansion device 58, or throttling, is used to control a temperature of the refrigerant within the second heat exchanger 62. Increasing a pressure drop necessarily lowers the temperature of the refrigerant within the second heat exchanger 62.

In the described embodiment, the control module 16 is electrically connected to the second expansion device 58 (as shown by dashed line) and operates to control pressure drop of the refrigerant moving through the expansion device to ensure optimal performance. In the described embodiment, the second expansion device 58 is an electronic expansion device having an opening therein which the refrigerant passes through. The control module 16 controls a size of the opening within the expansion device 58. The size of the opening determines a pressure drop of the refrigerant moving through the device 58. The pressure drop is adjusted dependent upon the same input used to calculate the desired power of the compressor by the control module 16. In alternate embodiments, the expansion device could be fixed orifice tubes with associated bypass devices that together provide a specific drop in pressure.

In the described embodiment, the second heat exchanger 62 functions as an evaporator. When the described embodiment is used in vehicle cabin cooling, the evaporator 62 may be positioned within a heating, ventilation, and air conditioning (HVAC) case of the vehicle, or elsewhere. Warm, moist air flowing across the evaporator 62 transfers its heat to the cooler refrigerant within the evaporator. The byproducts are a lowered temperature air and possible condensation from the air that is routed from the evaporator 62 to an exterior of the vehicle. Although not depicted, a blower blows air across the evaporator and through a vent to the passenger compartment as is known in the art. This process results in the passenger compartment having a cooler, drier air therein.

Within the evaporator 62, the low-pressure, low-temperature vapor and liquid refrigerant mixtures absorbs heat from the secondary fluid (e.g., air or water) that flows across the evaporator 62 as shown by arrows 76 and 78. The low-pressure, low-temperature vapor refrigerant or vapor-liquid mixture exits the evaporator 62, as shown by action arrow 66, and is received in an accumulator 68, where any liquid is stored. Only a low-pressure, low-temperature vapor refrigerant exits the accumulator 68, as shown by action arrow 70. The vapor refrigerant is received at the first suction port 22 of the first impeller 18 of the compressor 12 where the vapor refrigerant is again compressed and cycled through the system 10.

A thermocouple 72 senses a temperature (T₂) of the refrigerant outlet from the accumulator 68 prior to entering the compressor 12. Although the thermocouple 72 is depicted in FIG. 1 near an outlet of the accumulator 68, the thermocouple, or a different type of temperature sensor in an alternate embodiment, could be positioned anywhere between the compressor 12 and the accumulator 68. The thermocouple 72 is electrically connected (as shown by dashed line) to the control module 16 which receives the sensed temperature (T₂) of the refrigerant for use in calculating the desired power of the compressor 12.

Similarly, a transducer 74 senses a pressure (P₂) of the refrigerant outlet from the accumulator 68 prior to entering the compressor 12. Although the transducer 74 is depicted in FIG. 1 adjacent the thermocouple 72, the transducer, or a different type of pressure sensor in an alternate embodiment, could be positioned near an outlet of the accumulator 68, or anywhere between the compressor 12 and the accumulator 68. The transducer 74 is electrically connected (as shown by dashed line) to the control module 16 which receives the sensed pressure (P₂) of the refrigerant for use in calculating the desired power of the compressor 12.

In the compressor 12, the refrigerant is again compressed and cycled through the system 10. More specifically, compression of low-pressure, low-temperature vapor from the accumulator 68 within the first impeller 18 and compression of intermediate-pressure, intermediate-temperature vapor from the separator 56 within the second impeller 20 occur at the same time. As indicated above, the compressed refrigerants from the first and second impellers of the compressor 12 are merged prior to being directed to the gas cooler 34.

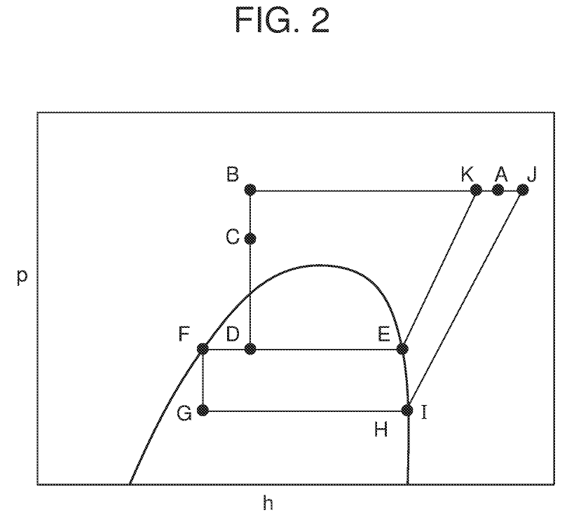

FIG. 2 is a pressure-enthalpy diagram of the cooling system 10 with the compressor 12 with dual impellers operating in parallel in a cooling mode. The reference letters on the diagram correspond to locations within the system 10, as shown in FIG. 1. For example, reference letter A is positioned at a point where the compressed refrigerants from the first and second impellers of the compressor 12 are merged prior to entering the gas cooler 34. Even more, I-J refers to the compression within the first impeller 18, E-K refers to the compression within the second impeller 20, B-C refers to the expansion within the first expansion device 44, and F-G refers to the expansion within the second expansion device 58.

As indicated above, the control module 16 in the described embodiment adjusts a speed of the motor/compressor shaft 14 and/or guide vane openings dependent upon certain factors. These factors include at least a condition of the secondary fluid and the sensed temperatures (T₁ and T₂) and the sensed pressure (P₁) of the primary fluid. As described above, the sensed temperatures T₁ and T₂ and the sensed pressure P₁ are determined at different locations within the system. The condition of the secondary fluid may be its temperature (T_{A}) (e.g., at the inlet or the outlet of second heat exchanger 62). Depending upon the calculated desired power, a parameter of the compressor 12 may be adjusted (e.g., opening of impeller vanes) and/or a pressure drop of the refrigerant may be changed within the expansion device(s). While the control module is effective across all temperatures of the secondary fluid and attempts to improve system efficiency across the entire operating range, the degree of improvement varies at different operating conditions.

Algorithms within the control module, for example, react to the temperature (T_{A}) of the secondary fluid. Referring generally to the pressure-enthalpy (p-h) diagram in FIG. 2, at a certain secondary fluid inlet temperature, there is a corresponding evaporating temperature T₁ and evaporating pressure P₁ (note that T/P are constant on line G-H). The warmer the secondary fluid temperature (T_{A}), the higher the evaporating temperature and evaporating pressure. Given T₁, P₁ and T₂, there is an optimal discharge pressure (P_{d}=P_{B}=P_{K}=P_{A}=P_{J}) and intermediate pressure (Pₘ=P_{F}=P_{D}=P_{E}) that yields a maximum coefficient of performance (COP). The compressor power required to achieve such optimal operating conditions is then calculated, i.e., a heat of compression, compressor work, or compressor power, is calculated.

With reference to FIG. 1, the refrigeration capacity and compressor work are calculated as Qₑ=(1-x_{D})(h_{H}-h_{F}) and Wₑ=x_{D}(h_{K}-h_{E})+(1-x_{D})(h_{J}-h_{I}), where x_{D}=(h_{D}-h_{F})/(h_{E}-h_{F}). Given the evaporator refrigerant outlet pressure, and heat exchanger (e.g., evaporator and gas cooler) refrigerant outlet temperatures, there is an optimal intermediate pressure and discharge pressure for the maximum COP (=Qₑ/W_{c}). Given an evaporating temperature of 4 degrees Celsius (assuming saturated vapor at the evaporator outlet), gas cooler exit temperature of 38 degrees Celsius, and compressor isentropic efficiency of 80%, the optimal intermediate and discharge pressures are found to be 94.2 bar and 52.1 bar, respectively, yielding a maximum COP of 3.14. Utilizing parallel compression as described with regard to the embodiment in FIG. 1 improves the system efficiency by approximately 14.3% over a cycle with single compression.

The correlation of optimal discharge (P_{d}) and intermediate pressure (Pₘ) as a function of T₁, P₁, and T₂ is built into the control module as part of the algorithms. The control module then adjusts the compressor, for example, a motor/shaft speed and/or an opening of guide vanes for electric centrifugal compressors, to produce the required power (W_{c}). The control module also controls the opening size of the expansion device(s), in the described embodiment, to give the pressure drops of P_{B}-P_{C} or P_{F}-P_{G}.

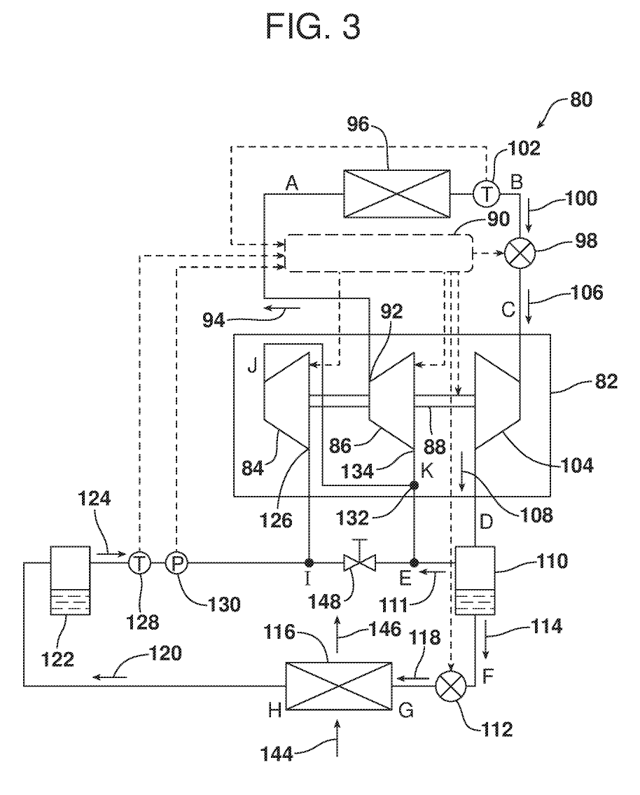

Reference is now made to FIG. 3 which illustrates a schematic diagram of a vapor compression cooling system 80 including a compressor 82. The cooling system 80 is generally the same as the system described with regard to FIG. 1 except the compressor 82 uses multi-stage compression within first and second impellers 84, 86. In other words, the first impeller 84 and the second impeller 86 of the compressor 82 operate in series to compress the fluid in a cycle including a first compression and a second compression. More specifically, the compressor 82 includes a single shaft 88 shared by the first and second impellers 84, 86 and driven by a variable speed motor (not shown). A control module 90 is electrically connected to the compressor 12 (as shown by dashed line) and adjusts a parameter of the compressor dependent upon at least a condition of a secondary fluid that provides heat to a primary fluid (e.g., a refrigerant) as described above.

In the described embodiment, a high-pressure, high-temperature vapor refrigerant exits the compressor 82 via a first discharge port 92, as shown by action arrow 94, and fed to a first heat exchanger 96. In the described embodiment where the refrigerant is R744, the first heat exchanger 96 is a gas cooler. Within the gas cooler, the high-pressure, high-temperature vapor refrigerant is cooled to a high-pressure, low-temperature vapor by a cooling fluid, for example ambient air or water. The fluid flow over the first heat exchanger 96 may be created and regulated by fans for air or pumps for water.

The cooled, high-pressure liquid refrigerant is sent to a first expansion device 98 as shown by action arrow 100. A thermocouple 102 senses a temperature (T₁) of the refrigerant outlet from the first heat exchanger 96 prior to entering the first expansion device 98. The thermocouple 102 is electrically connected to the control module 90 which receives the sensed temperature (T₁) of the refrigerant for use in calculating a desired power of the compressor 82. The desired power is calculated using the sensed temperature (T₁), a second sensed temperature (T₂) and a sensed pressure (P₁) of the refrigerant, and the condition of the secondary fluid (e.g., a temperature (T_{A}) of the secondary fluid at an inlet of second heat exchanger 116) as described above for the embodiment shown in FIG. 1. Depending upon the calculated desired power, a parameter of the compressor 82 is adjusted. For example, the motor speed and/or guide vane openings of the impellers of the compressor 82 may be adjusted.

In the first expansion device 98, the outlet refrigerant from the first heat exchanger 96 is expanded and supplied to an expander 104 of the compressor 82 as shown by action arrow 106. The expander 104 expands the refrigerant to produce work that is used to drive the shaft 88 of the centrifugal compressor 82. The recovery of expansion work reduces the compressor load and improves system efficiency.

The control module 90 is electrically connected to the expansion device 98 (as shown by dashed line) and operates to control a pressure drop of the refrigerant moving through the expansion device to ensure optimal performance. In the described embodiment, the first expansion device 98 is an electronic expansion device having an opening therein which the refrigerant passes through. The control module 90 controls a size of the opening within the expansion device 98 that determines the drop in pressure of the refrigerant moving through the device. The pressure drop is adjusted dependent upon the same inputs used to calculate the desired power of the compressor by the control module 90. In alternate embodiments, the expansion device could be fixed orifice tubes with associated bypass devices that together provide a specific drop in pressure.

An intermediate-temperature, intermediate-pressure vapor and liquid refrigerant mixture leaves the expander 104, as shown by action arrow 108, and is received in a separator 110. As will be described in more detail below, an intermediate-pressure, intermediate-temperature vapor refrigerant exits the separator 110, as shown by action arrow 111, and is received in the second impeller 86 of the compressor 12.

The separated liquid refrigerant within the separator 110 is sent as an intermediate-pressure, intermediate-temperature liquid refrigerant to a second expansion device 112 as shown by action arrow 114. In the second expansion device 112, the intermediate-pressure, intermediate-temperature liquid refrigerant is expanded to become a low-pressure, low-temperature liquid and vapor refrigerant mixture that is supplied to a second heat exchanger 116 as shown by action arrow 118. Regulation of the flow of refrigerant through the expansion device 112, or throttling, is used to control a temperature of the refrigerant within the second heat exchanger 116. Increasing a pressure drop necessarily lowers the temperature of the refrigerant within the second heat exchanger 116.

Again, the control module 90 is electrically connected to the second expansion device 112 (as shown by dashed line) and operates to control the pressure drop of the refrigerant moving through the expansion device to ensure optimal performance. In the described embodiment, the second expansion device 112 is an electronic expansion device having an opening through which the refrigerant passes. The control module 90 controls a size of the opening within the expansion device 112 that determines a pressure drop of the refrigerant moving through the device. The pressure drop is adjusted dependent upon the same inputs used to calculate the desired power of the compressor by the control module 90.

In the embodiment shown in FIG. 3, the second heat exchanger 116 functions as an evaporator. When the described embodiment is used in vehicle cabin cooling, the evaporator 116 is used to cool a passenger compartment (not shown). Warm, moist air flowing across the evaporator 116 transfers its heat to the cooler refrigerant within the evaporator. The byproducts are a lowered temperature air and possible condensation from the air, which are routed from the evaporator 116 to an exterior of the vehicle. Although not depicted, a blower blows air across the evaporator and through a vent to the passenger compartment as is known in the art. This process results in the passenger compartment having a cooler, drier air therein.

Within the evaporator 116, the low-pressure, low-temperature vapor and liquid refrigerant mixture absorbs heat from the secondary fluid (e.g., air or water) that flows across the evaporator as shown by action arrows 144 and 146. The low-pressure, low-temperature vapor refrigerant exits the evaporator 116, as shown by action arrow 120, and is received in an accumulator 122, where any liquid is stored. Only a low-pressure, low-temperature vapor refrigerant exits the accumulator 122, as shown by action arrow 124. The vapor refrigerant is received at the first suction port 126 of the first impeller 84 of the compressor 82 where the vapor refrigerant is again compressed.

A thermocouple 128 senses a temperature (T₂) of the refrigerant outlet from the accumulator 122 prior to entering the compressor 82. Although the thermocouple 128 is depicted in FIG. 3 near an outlet of the accumulator 122, the thermocouple, or a different type of temperature sensor in an alternate embodiment, could be positioned anywhere between the compressor 82 and the accumulator 122. The thermocouple 128 is electrically connected (as shown by dashed line) to the control module 90 which receives the sensed temperature (T₂) of the refrigerant for use in calculating the desired power of the compressor 82.

Similarly, a transducer 130 senses a pressure (P₂) of the refrigerant outlet from the accumulator 122 prior to entering the compressor 82. Although the transducer 130 is depicted in FIG. 3 adjacent the thermocouple 128, the transducer, or a different type of pressure sensor in an alternate embodiment, could be positioned near an outlet of the accumulator 122, or anywhere between the compressor 82 and the accumulator 122. The transducer 130 is electrically connected (as shown by dashed line) to the control module 90 which receives the sensed pressure (P₂) of the refrigerant for use in calculating the desired power of the compressor 82.

In the first impeller 84, the low-pressure, low-temperature vapor refrigerant is compressed in a first stage of a cycle. The resulting intermediate-pressure, intermediate-temperature vapor refrigerant is then merged with the intermediate-pressure, intermediate-temperature vapor from the separator 110 at merger point 132. The merged refrigerant vapors are received at a first suction port 134 of the second impeller 86 where the merged refrigerant is again compressed in a second stage of the cycle into a high-pressure, high-temperature vapor refrigerant, and cycled through the system 80.

In accordance with the method of operating a vapor compression cooling system, a first fluid is compressed in a first and a second compression cycle of a compressor 12. In one embodiment, the first and second compression cycles occur in first and second impellers 18, 20 of the compressor operating in parallel.

In other steps, a temperature of a secondary fluid at an inlet of a second heat exchanger is determined and a temperature of the primary fluid is sensed. In the described embodiment, the temperature of the primarily fluid outlet from a first heat exchanger is also sensed. In another step, a second temperature and a pressure of the primary fluid are sensed. In the described embodiment, the second temperature and the pressure of the primary fluid outlet from an accumulator are sensed. In another step, a desired power of the compressor 12 is calculated based on the determined temperature of the secondary fluid and sensed temperatures and pressure of the primary fluid. The algorithms utilized to calculate the desired power within the control module are broadly described above and may rely on additional operating conditions of the system (e.g., required temperature of the secondary fluid at an outlet of the second heat exchanger). Dependent upon the calculated desired power of the compressor, a parameter of the compressor is adjusted. In the described embodiment, a speed of the motor/shaft driving the compressor or guide vane openings of the impellers of the compressor may be adjusted.

In another embodiment, the method may include the step of changing a pressure of the primary fluid dependent upon the calculated desired pressure drop P_{B}-P_{C} and/or P_{F}-P_{G}. This step may be accomplished by adjusting a size of an opening of at least one of the expansion devices through which the primary fluid moves. In another embodiment, the first heat exchanger cools the compressed high-temperature primary fluid vapor and the second heat exchanger functions as an evaporator that heats low-temperature primary fluid.

In summary, numerous benefits result from the vapor compression cooling systems 10, 80 and related method of operating the systems as illustrated in this document. The systems are capable of adjusting a compressor dependent upon at least a condition of a secondary fluid that provides heat to a primary fluid and other parameters to achieve optimal conditions and improve system efficiency.

The foregoing has been presented for purposes of illustration and description. It is not intended to be exhaustive or to limit the embodiments to the precise form disclosed. Obvious modifications and variations are possible in light of the above teachings. For example, the devices controlled by control module 16 in the described embodiment could be controlled by a plurality of control modules or similar devices. The plurality of control modules could each control one or more devices within the system and communicate with one another via a network (e.g., a controller area network (CAN) bus commonly used in vehicles). Even more, the compressor could utilize more than two impellers and could function without an expander albeit in a less efficient manner. All such modifications and variations are within the scope of the appended claims when interpreted in accordance with the breadth to which they are fairly, legally and equitably entitled.

What is claimed:

1. A vapor compression cooling system, comprising:
a centrifugal compressor for compressing a primary fluid in a cycle including at least two compressions; and
a control module for controlling said centrifugal compressor dependent upon at least one condition of a secondary fluid.

2. The vapor compression cooling system of claim 1, wherein said control module controls a power of said centrifugal compressor.

3. The vapor compression cooling system of claim 2, wherein said centrifugal compressor is an electric centrifugal compressor driven by a motor, and said control module controls the power of said electric centrifugal compressor by adjusting a speed of said motor.

4. The vapor compression cooling system of claim 2, wherein said centrifugal compressor is an electric centrifugal compressor including first and second impellers driven by a motor, and said control module controls the power of said electric centrifugal compressor by adjusting an opening of guide vanes associated with at least one of said first and second impellers.

5. The vapor compression cooling system of claim 1, wherein said centrifugal compressor is an electric centrifugal compressor including first and second impellers and an expander driven by a motor.

6. The vapor compression cooling system of claim 5, wherein said first and second impellers operate in parallel.

7. The vapor compression cooling system of claim 5, wherein said first and second impellers operate in stages.

8. The vapor compression cooling system of claim 5, wherein said centrifugal compressor includes a single shaft shared by said first and second impellers and said expander, and driven by said motor.

9. The vapor compression cooling system of claim 1, further comprising first and second expansion devices, and wherein said control module further controls said first and second expansion devices dependent upon at least a condition of a secondary fluid.

10. The vapor compression cooling system of claim 9, further comprising a first temperature sensor for sensing a temperature of the primary fluid outlet from a first heat exchanger, and a second temperature sensor for sensing a temperature and a first pressure transducer for sensing a pressure of the primary fluid outlet from an accumulator, wherein said control module controls said centrifugal compressor dependent upon the condition of the secondary fluid, the first sensed temperature, the second sensed temperature, and the first sensed pressure.

11. The vapor compression cooling system of claim 10, wherein said first and second expansion devices are electronic expansion devices, and said control module controls a pressure drop of the primary fluid moving through said first and second expansion devices.

12. The vapor compression cooling system of claim 1, wherein the secondary fluid is at least one of air, water, coolant, and refrigerant, and the condition of the secondary fluid includes at least one of a temperature of the secondary fluid, a humidity of the secondary fluid, and an ambient solar load.

13. The vapor compression cooling system of claim 9, wherein said control module controls a power of said centrifugal compressor, and wherein said centrifugal compressor is an electric centrifugal compressor driven by a motor, and said control module controls the power of said electric centrifugal compressor by adjusting at least one of a speed of said motor and an opening of guide vanes in said centrifugal compressor.

14. A vapor compression cooling system, comprising:
a centrifugal compressor having at least two impellers for compressing a primary fluid in a cycle including at least two compressions;
a first heat exchanger through which the primary fluid moves;
a first expansion device through which the primary fluid moves;
a separator for separating vapor and liquid of the primary fluid;
a second expansion device through which the primary fluid moves;
a second heat exchanger for boiling the primary fluid;
an accumulator for storing liquid primary fluid and allowing only vapor primary fluid to enter said centrifugal compressor; and
a control module for controlling said centrifugal compressor and said first and second expansion devices dependent upon a condition of secondary fluid.

15. The vapor compression cooling system of claim 14, further comprising a bypass valve that may be used to adjust a suction pressure of at least one of first and second impellers.

16. The vapor compression cooling system of claim 14, wherein said control module further controls said compressor and said first and second expansion devices dependent upon at least one of a first temperature of the primary fluid between said first heat exchanger and said first expansion device, a second temperature of the primary fluid between an accumulator and said compressor, and a pressure of the primary fluid between said accumulator and said compressor.

17. A method of operating a vapor compression cooling system, comprising the steps of:
compressing a primary fluid in a first compression and a second compression cycle of a centrifugal compressor having first and second impellers;
determining a condition of a secondary fluid;
sensing a temperature of the primary fluid outlet from a first heat exchanger;
sensing a temperature and a pressure of the primary fluid outlet from an accumulator;
calculating a desired power of said centrifugal compressor based on the condition of the secondary fluid and the sensed temperature outlet from said first heat exchanger and the sensed temperature and pressure outlet from said accumulator; and
adjusting a parameter of said centrifugal compressor dependent upon the calculated desired power of said centrifugal compressor.

18. The method of operating a vapor compression cooling system of claim 17, wherein the step of adjusting a parameter of said centrifugal compressor includes adjusting at least one of a speed of a motor driving said centrifugal compressor and an opening of guide vanes in said centrifugal compressor.

19. The method of operating a vapor compression cooling system of claim 17, further comprising the steps of calculating a desired pressure drop based on the condition of the secondary fluid, the sensed temperature outlet from said first heat exchanger, and the sensed temperature and pressure outlet from said accumulator; and changing a pressure of the primary fluid dependent upon the calculated desired pressure drop.

20. The method of operating a vapor compression cooling system of claim 19, wherein the step of changing the pressure of the primary fluid includes adjusting an opening size of at least one expansion device through which the primary fluid moves.
